(19) United States
(12) Patent Application Publication
(10) Pub. No.: US 2016/0242878 A1
(43) Pub. Date: Aug. 25, 2016

(54) DENTAL IMPRESSION DEVICE, DENTAL IMPRESSION SET AND METHOD FOR MOULDING AND CORRECTLY POSITIONED REGISTRATION OF A JAW ARRANGEMENT

(71) Applicant: Merz Dental GmbH, Lutjenburg (DE)

(72) Inventor: Frank POERSCHKE, (US)

(21) Appl. No.: 14/442,683

(22) PCT Filed: Nov. 15, 2013
(86) PCT No.: PCT/EP2013/003458

§ 371 Date: Feb. 17, 2016

(51) Int. Cl. A61C 9/00

(52) U.S. Cl. CPC A61C 9/0006

(57) ABSTRACT

The invention describes a dental impression with at least one spoon-shaped dental impression tray, characterized in that the dental impression tray has at least one position marker.

The present invention relates to a dental impression device, a dental impression set and a method for moulding and correctly positioned registration of a jaw arrangement.

Generally, in order to mould a jaw arrangement, a dental impression tray is used which, preferably in the shape of a spoon, is designed to receive moulding materials and with which a plastic mould is made for both the upper and the lower jaw. Once the mould has been made, the occlusal plane is determined with the aid of a bite template and a so-called bite fork for the correct positioning of the jaws in an articulator. Instead of the known plastic moulding, over the last few years the step of “digital moulding” has been taken by dental technicians. In this connection, moulding with the aid of a conventional spoon impression can be dispensed with because corresponding regions of the situation in the patient's oral cavity are scanned digitally by means of a special optical recording unit. The advantage of this “digital moulding” is that the dentist is given the possibility, almost in real time, of recognising whether these data are sufficient for a digital image of the situation, but the digital quality is dependent upon the soft- and hardware used. The digital recording of the oral situation has previously been restricted to the production of cementable prosthetic fittings with the residual dentition that is present. Once the digital data are available, i.e. the digitally recorded oral cavity of the patient, by means of the data the facts relating to the respective upper and lower jaw are re-produced and also the occlusal reference for the restoration is prepared in an articulator. Nevertheless, depending on the precision and the error-free work of the dental technician, the dentist has to adapt the restoration/s in situ, possibly in a number of processes. It may in part be necessary to go back to the dental technician with problematic occlusion positions depending on error frequency and inaccuracy. Due to the so-called matching process, inaccuracies also occur in a digital scan which may turn out to be correspondingly large depending on the jaw extension.

The optimal alignment and positioning of the upper jaw situation in relation to the lower jaw situation is problematic with all well-established methods, whether in analogue moulding or digital recording. The respective procedural steps both of the dental technician and the dentist can be influenced depending on the accuracy of the alignment of the prosthetic restoration between the upper jaw and the lower jaw. It must therefore be established that the moulding of the jaws and the recording of the correct relationship to one another constitute the most important link between the treatment on the patient carried out by the dentist and the work in the laboratory carried out by the dental technician.

Therefore, the object of the present invention is to provide a high degree of accuracy with regard to the respective positions of the upper jaw situation and the lower jaw situation by means of the moulding process.

This object is achieved by the features according to claim 1 corresponding to the dental impression device, according to claim 7 corresponding to the dental impression set, and according to claim 12 corresponding to the method for moulding and correctly positioned registration of a jaw arrangement.

According to the application, a spoon-based jaw moulding method (referred to in the following as a dental impression tray) is used which has at least one position marker. By means of this position marker according to the application it is possible to determine by almost one hundred per cent the respective moulded jaw according to the positioning in an articulator. The adjustment effort required of the dental technical should thus be reduced to a minimum. With this position marker it is therefore possible for the upper jaw mould and the lower jaw mould to be aligned and encoded both horizontally and vertically. The position marker makes it possible to transfer the jaw relationship to an articulator. One thus creates the possibility of producing a software-supported dental prosthesis construction in the correct occlusal relationship. With the dental impression tray according to the application with at least one position marker a “bi-functional” moulding spoon is thus provided which, as well as the well-established function, i.e. the moulding of the respective jaw function and topography, additionally also has the function of fixing the position of the tooth impression as such. According to the application, the basic concept behind the dental impression tray according to the application consists of the moulding and the correctly positioned registration of the jaws being provided in one sitting. Thus, as well as moulding both jaws, it is also possible to register the bite in one procedural step.

Additional advantageous configurations are the subject matter of the sub-claims.

If, for example, the position marker is provided in the bottom region of the dental impression tray as a notch or recess, a position marker is provided by means of the simple technical implementation which advantageously is to be found once again in the outer surface of the spoon and correspondingly enables positionable allocation of the upper jaw to the lower jaw.

An advantageous arrangement of the position marker in the labial region enables in particular the simple allocation of the jaws in corresponding software.

It has proven to be particularly advantageous if at least three position markers are provided because the alignment of the respective upper and lower jaws can thus be configured more optimally. In this connection reference is made in particular to the advantages for optimal position fixing corresponding to a three-point contact.

Depending on the size of the mould to be made, and so also of the dental impression tray, it is advantageous, for example, to provide five position markers. If in particular an odd number of position markers are made according to the application, a symmetrical arrangement in relation to the centrally located position marker is respectively possible.

It is also advantageous, for example, if the position markers are arranged rotationally symmetrically because in this way the allocation and positioning of the upper and the lower jaw can be undertaken more simply. The advantage of a rotationally symmetrical arrangement is that with different spoon sizes of the dental impression tray, the different sizes are compensated by the different radii.

Due to the provision of a bite registration element, in the interaction with the position markers of the dental impression tray during the moulding process, an adaptation is made with which both the position of the jaws in relation to one another, the position of the teeth in relation to one another and also the horizontal occlusion position is determined. By means of this measure it is possible for the error sources, which can for example occur with separate moulding of an upper jaw and a lower jaw, which then require complex reworking by the dental technician in the articulator, to no longer be present according to the application. Due to the presence of the position markers, which are also to be found once again in the bite registration element, for example due to the impressions with the presence of a recess or notch in the bite registration element, one can in this regard dispense with technically more complex digital moulding.

If the bite registration element is made to be deformable so as to be able to follow the shape of the position markers, if so required, it is preferably reproducible so that the bite registration element is nevertheless warp- and torsion-resistant so as to thus enable positioning for simple handling by the dental technician.

If, moreover, the position marker is configured as a so-called surface pairing, the possibility is created of the surface pairing also being reproduced in the articulator, and so there being almost one hundred per cent positioning of the jaw position of the upper and the lower jaw. The surface pairing of the position marker also increases the positional fixing in interaction with the bite registration element so that after producing the mould the dental technician does not have to make any complex correction in the articulator.

If, moreover, the bite fork is additionally used to determine the occlusal plane, almost all possible parameters are available for the production of a synthetic dental prosthesis, the moulding of the respective upper and lower jaw contour required for this taking place in one treatment sitting.

Another advantageous configuration of the following invention is the subject matter of the other sub-claims.

Additional advantages, features and possible applications of the present invention emerge from the following description of preferred exemplary embodiments in association with the drawings.

These show as follows:

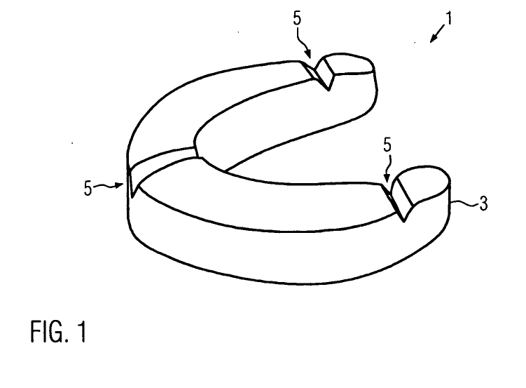

FIG. 1 the dental impression tray according to the application

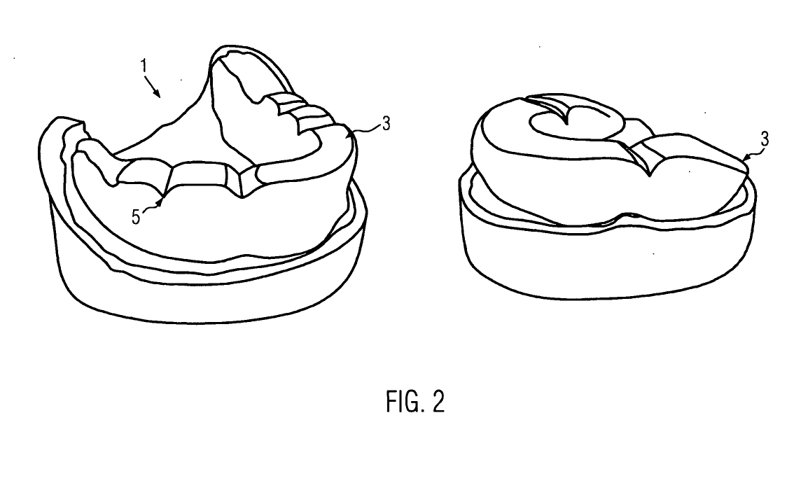

FIG. 2 a perspective illustration of both embodiments of the dental impression tray in a suggested mandibuloplasty

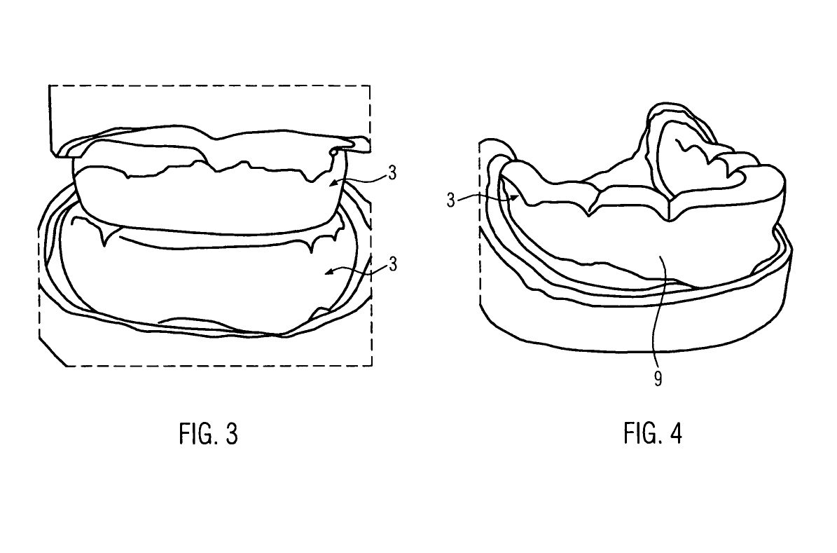

FIG. 3 a front view of the dental impression tray according to the application for an upper and a lower jaw respectively

FIG. 4 a perspective top view of the dental impression tray according to the application for the lower jaw with plastic moulding compound

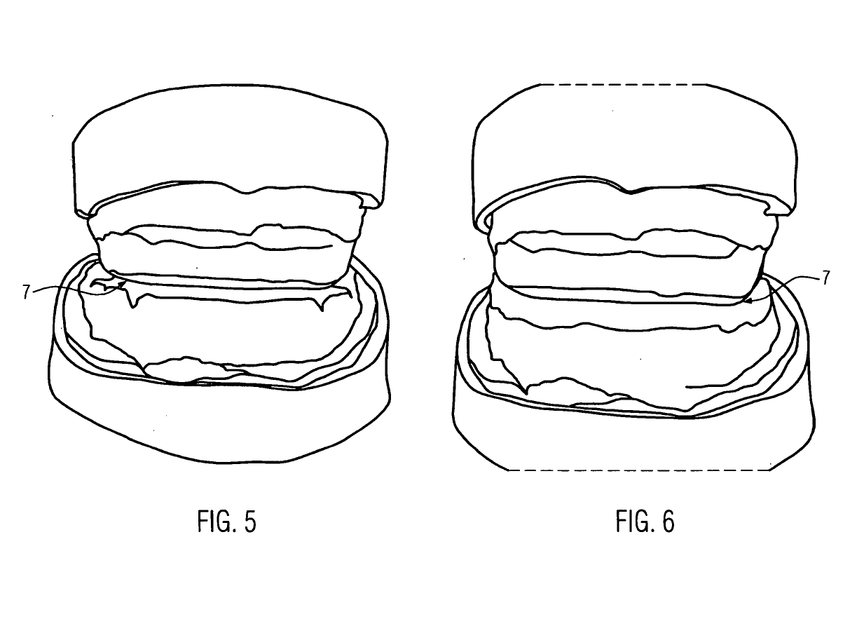

FIG. 5 a front view of the dental impression device according to the application with a bite registration element

FIG. 6 a dental impression device according to the application with a bite registration element and plastic moulding compound

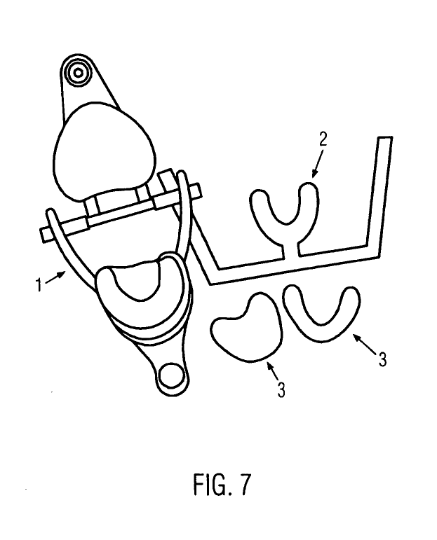

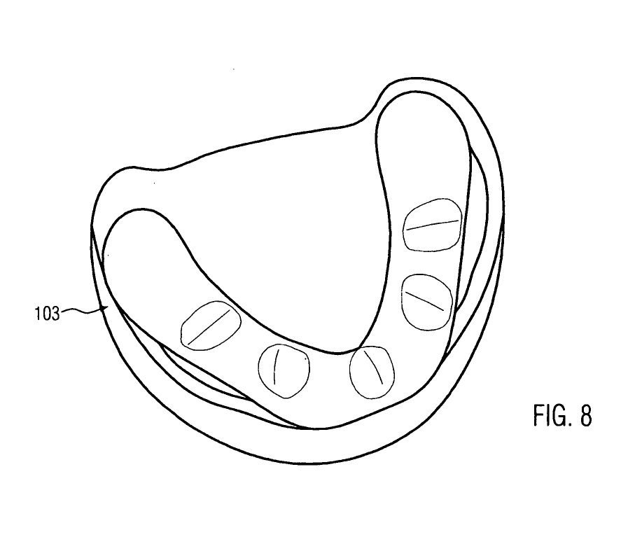

FIG. 7 an overall illustration of the dental impression set

FIGS. 8, 9, 10 another configuration of the dental impression tray shown in FIGS. 2 and 3

In FIG. 1 the dental impression device 1 according to the application is shown which, in this case, has a dental impression tray 3 for the lower jaw, in this configuration the dental impression tray including position markers 5 and, according to the embodiment, 3 position markers. In this form the position markers are provided as recesses or notches which extend from palatinal or lingual to labial, and the vestibularly arranged recess 5 preferably being positoned centrally or rotationally symmetrically.

On the left of FIG. 2, a configuration of a mandibular dental impression tray 3 is shown which preferably has 5 position markers 5, the vestibular position marker 5 not being carried through to the lingual side. On the right-hand side another configuration of a mandibular dental impression tray 3 is shown which preferably has two position markers 5 and only shows the position markers 5 in the buccal region.

In FIG. 3 the dental impression device and the dental impression set is shown in a front view which shows both a mandibular and a maxillary dental impression tray.

FIG. 4 shows the mandibular dental impression tray which is provided with a plastic filling compound 9 for the mould of the lower jaw.

In FIG. 5 the dental impression set used is shown in a front view which additionally includes the bite registration element 7 which can be positioned between the bite registration element for the upper and the lower jaw, i.e. between the maxillary and the mandibular dental impression tray 3.

In FIG. 6 the bite registration element 7 with the plastic moulding compound is positioned so that the precise positional fixing between the upper and the lower jaw can be directly determined in one moulding process.

FIG. 7 shows a complete dental impression set, the situation in the articulator being an example for a patient. The dental impression set further comprises a bite fork 2 which serves to examine the occlusal plane in relation to the “Camper's plane”. With the aid of the bite fork the upper jaw dental impression device is aligned at certain reference points to the “Camper's plane”. Thus on the one hand the upper jaw spoon has moulded the mucosa situation, and in addition, due to the alignment by means of the bite fork it additionally contains information on the occlusal plane. Furthermore, a dental impression device for the upper jaw and for the lower jaw is shown here. The moulding process according to the application initially makes provision for a patient situation without teeth which is shown on the basis of FIG. 1 by means of the situation in the articulator for a patient. First of all the upper jaw is positioned correctly by means of a bite fork and by means of references relating to the skull. Serving as a key here is a moulding compound which is provided as the carrier of specific situation data which can be converted by almost 100% into a digital workflow by means of the position markers and so contains information with regard to the occlusal plane. After the pre-positioning with all of the important reference points the functional moulding is carried out, i.e. after inserting the dental impression device both for the upper and for the lower jaw, which has the corresponding position markers, a bite registration element is positioned between the upper jaw dental impression tray and the lower jaw dental impression tray, by means of which the reference for both dental impression trays is established, and so is provided by means of the bite registration element. With the aid of a hard silicon the lower jaw is thus aligned and encoded horizontally and vertically to the upper jaw. Here the position markers in particular play a particular encoding role because, by means of the position markers, the positional fixing of the upper and the lower jaw, and also the impressions in the bite registration element allows optimal spatial fixing, by means of which all necessary reference points are provided with a moulding process, and this reduces reworking by the dental technician and the dentist to a minimum.

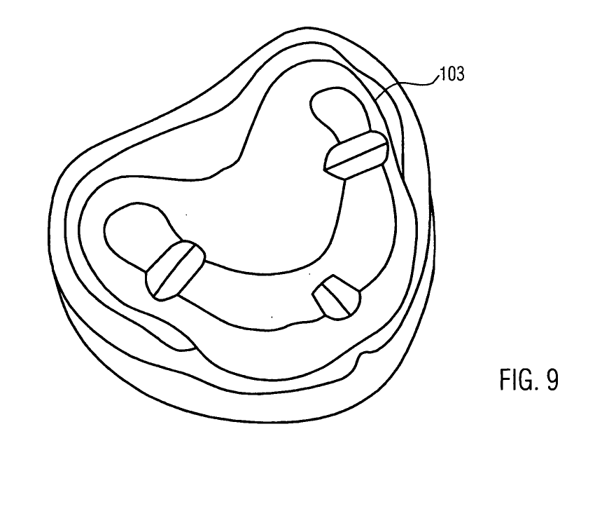

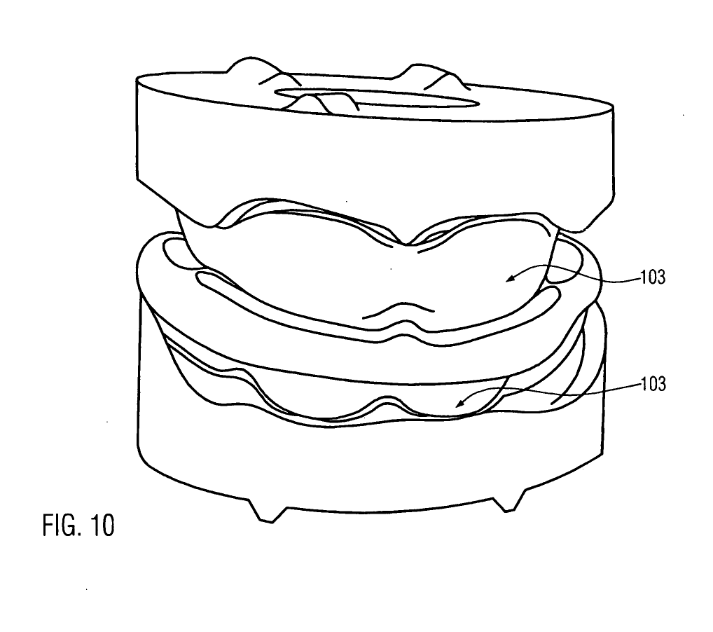

FIGS. 8 and 9 show additional embodiments of the dental impression trays 103 according to the application for the upper and the lower jaw, FIG. 10 showing a perspective front view in interaction for the upper and the lower jaw.

1. A dental impression device comprising at least one spoon-shaped dental impression tray, wherein the dental impression tray has at least one recess arranged vestibularly and centrally as a first position marker.

2. The dental impression device of claim 1, wherein the position marker is provided in the bottom region of the dental impression tray as a notch or recess.

3. The dental impression device of claim 1, wherein the position marker is provided in the labial region.

4. The dental impression device of claim 1, wherein at least three position markers are provided.

5. The dental impression device of claim 4, wherein five position markers are provided.

6. The dental impression device of claim 4, wherein the other two, three or four position markers are arranged mirror-symmetrically and centrally in relation to the plane of symmetry defined by the centrally arranged first position marker.

7. The dental impression device of claim 1, comprising an upper side dental impression tray with at least one recess arranged vestibularly or centrally as the first position marker for the upper jaw, a lower side dental impression tray with at least one recess arranged vestibularly and centrally as the first position marker for the lower jaw, and a bite registration element.

8. The dental impression set device of claim 7, wherein the bite registration element is capable of being positioned between the dental impression trays.

9. The dental impression device of claim 7, wherein the bite registration element is deformable.

10. The dental impression device of claim 7, wherein the position markers are provided as a surface pairing.

11. The dental impression device of claim 7, further comprising a bite fork.

12. A method for molding and correctly positioned registration of a jaw arrangement, using the dental impression device of claim 7, comprising:
a) providing a dental impression tray with at least one recess positioned vestibularly and centrally as the first position marker for the upper and the lower jaw, and
b) positioning a bite registration element between the dental impression trays.

13. The method of claim 12, wherein the correctly positioned registration is undertaken by aligning the dental impression tray for the upper and the lower jaw by means of the bite registration element and the position markers provided.

14. The method of claim 12, wherein the dental impression trays are equipped with commercially available moulding materials.

15. The method according to claim 12, wherein a bite fork is provided, and the occlusal plane is determined using the bite fork prior to use of the bite registration element.

16. The dental impression device of claim 7, wherein the bite registration element is warp- and torsion-resistant.

17. The dental impression device of claim 7, wherein the position markers are provided as a surface pairing in the bottom region of their respective dental impression trays.
